(19) United States
(12) Patent Application Publication
(10) Pub. No.: US 2005/0172831 A1
(43) Pub. Date: Aug. 11, 2005

(54) Locking device for household bean milk and bean curd makers

(76) Inventor: Hong-bae Kim, Koyang-city (KR)

Correspondence Address: SHLESINGER, ARKWRIGHT & GARVEY LLP;Suite 600, 1420 King Street, Alexandria, VA, 22314, US

(21) Appl. No.: 10/960,745

(22) Filed: Oct. 8, 2004

(30) Foreign Application Priority Data
Oct. 16, 2003 (KR) 2003-32482

(51) Int. Cl. A23L 1/20

(52) U.S. Cl. 99/452

(57) ABSTRACT

Disclosed herein is a locking device for household bean milk and bean curd makers. The maker includes a housing defining a cavity therein, and a main body provided on an upper portion of the housing to open or close the housing. The locking device includes a hook plate rotatably mounted to a predetermined position on an outer surface of the housing, a hook rotatably coupled to the hook plate, and a locking catch protruding from a predetermined position on the main body to engage with the hook. The locking device for the household bean milk and bean curd makers locks the main body to the housing while compressing the main body and the housing against each other, thus offering a high resistance to vibration, and preventing accidents.

### CROSS-REFERENCE TO RELATED APPLICATIONS

This application claims the priority of Korean application no. 2003-32482, filed Oct. 16, 2003, which is incorporated herein by reference.

This application relates to Applicant's concurrently filed U.S. patent application (applicant's ref. 7397), entitled “Handle-Combined Locking Device for Household Bean Milk and Bean Curd Makers”, filed Oct. 8, 2004.

### FIELD OF THE INVENTION

The present invention relates generally to household bean milk and bean curd makers and, more particularly, to a locking device for the household bean milk and bean curd makers, which locks the main body to the housing of a household bean milk and bean curd maker while compressing the main body and the housing against each other, thus offering a high resistance to vibration, and preventing an accident.

### BACKGROUND OF THE INVENTION

A conventional method of making bean milk and bean curd has a problem in that several processes are individually executed, thus it is inconvenient and complicated to make bean milk and bean curd, and it takes longer time to make the bean milk and the bean curd, thereby the conventional method is inefficient.

In order to solve the problems, there have been proposed various devices for easily and conveniently making bean milk and bean curd at home. For example, there are Korean Patent No. 225772, Korean Patent No. 228659, Korean U.M. Registration No. 158856, Korean U.M. Registration No. 250843, etc, that are disclosed by the applicant of the present invention. The Korean Patent No. 225772 was published on Oct. 15, 1999, and is titled “household bean curd maker”. The Korean Patent No. 2000-228659 was published on Mar. 15, 2000, and is titled “household bean curd maker”. The Korean U.M. Registration No. 158856 was registered on Jul. 16, 1999, and is titled “household bean curd maker”. The Korean U.M. Registration No. 250843 was registered on Oct. 5, 2001, and is titled “household bean curd maker with fixed-type blade unit”.

A conventional household bean milk and bean curd maker will be described in the following with reference to the attached drawing.

FIG. 1 is a sectional view of the conventional household bean milk and bean curd maker. As shown in FIG. 1, the conventional household bean milk and bean curd maker includes a housing 1 which has a cavity to contain water therein. A main body 2 is provided on an upper portion of the housing 1 to open or close the housing 1, like a lid. A drive motor 3 is installed in a predetermined portion of the main body 2, and generates rotating power when electricity is applied to the drive motor 3. A drive shaft 4 transmits the rotating power from the drive motor 3. A cutting blade 5 is provided at an end of the drive shaft 4. A rod-shaped heater 6 downwardly extends from the main body 2, and generates heat when electricity is applied to the heater 6, thus heating an interior of the housing 1. A temperature sensing bar 7 detects the temperature of the interior of the housing 1. A filter net 8 is detachably mounted to a predetermined portion of the main body 2, and contains beans therein.

The conventional household bean milk and bean curd maker constructed as described above is operated as follows.

First, a user puts water into the housing 1. Beans are put into the filter net 8 which is detached from the main body 2, and then the filter net 8 containing the beans is mounted to the lower portion of the main body 2. Afterwards, the main body 2 is placed on the upper portion of the housing 1 so that the filter net 8 is put into the housing 1.

Next, when a power switch (not shown) is turned on to apply electricity to the household bean milk and bean curd maker, a control unit (not shown) outputs a control signal to operate the heater 6 and the temperature sensing bar 7. At this time, a primary heating process is executed while maintaining a predetermined temperature, for a predetermined period.

When the primary heating process has been completed, the control unit (not shown) outputs a control signal to operate the drive motor 3. As the drive motor 3 is operated, the beans contained in the filter net 8 are ground by the cutting blade 5 provided at the end of the drive shaft 4. While the beans are ground, turbulence of water contained in the housing 1 is caused by rotation of the cutting blade 5. By the turbulence, bean grains which are finely ground by the cutting blade 5 come out of the filter net 8. Thus, the beans ground by the cutting blade 5 are divided into bean-curd dregs which remain in the filter net 8, and the extract of protein which flows out of the filter net 8.

Thereafter, the control unit (not shown) outputs a control signal to operate the heater 6 and the temperature sensing bar 7. At this time, a secondary heating process is executed while maintaining a predetermined temperature, for a predetermined period. Through the above-mentioned process, bean milk is obtained.

When the user desires to make bean curd, the user takes the heated extract of protein out of the housing 1. Next, the coagulant is added to the heated extract of protein so as to coagulate the extract of protein. Thereafter, the coagulated protein is pressed in the frame to produce the bean curd.

However, the conventional household bean milk and bean curd maker has a problem in that excessive vibration may occur, if the maker is operated, while the main body 2 is not firmly coupled to the housing 1. Further, when the maker falls down due to the vibration, hot liquid may escape out of the maker, thus causing accidents.

### OBJECTS AND SUMMARY OF THE INVENTION

Accordingly, the present invention has been made keeping in mind the above problems occurring in the prior art, and an object of the present invention is to provide a locking device for household bean milk and bean curd makers, which locks the main body to the housing of a household bean milk and bean curd maker while compressing the main body and the housing against each other, thus offering a high resistance to vibration, and preventing an accident.

### BRIEF DESCRIPTION OF THE DRAWINGS

FIG. 1 is a sectional view of a conventional household bean milk and bean curd maker;

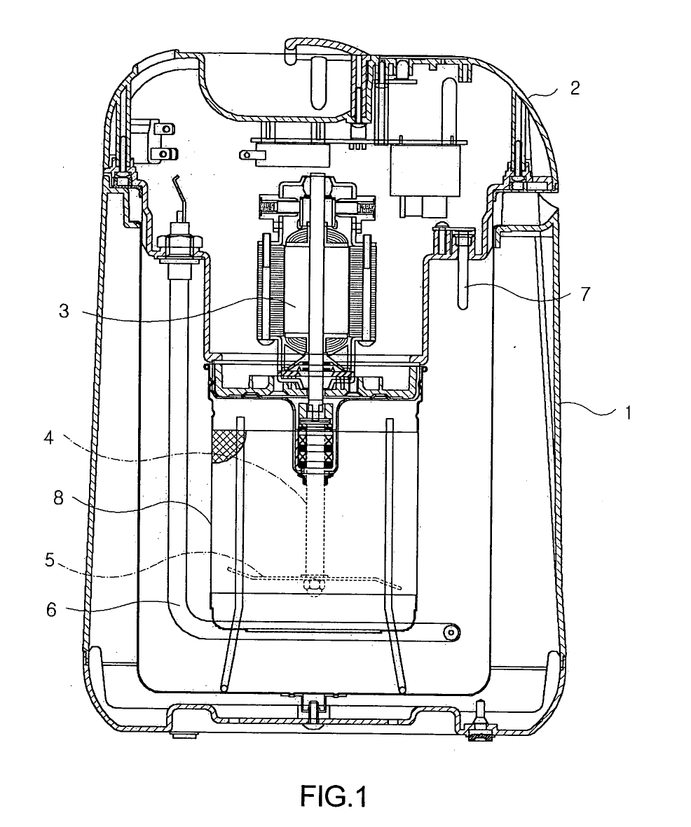

FIG. 2 is a perspective view of a locking device for a household bean milk and bean curd maker, according to the first embodiment of the present invention, when the maker is unlocked;

FIG. 3 is a perspective view of the locking device for the household bean milk and bean curd maker, according to the first embodiment of the present invention, when the maker is locked;

FIG. 4 is a front view to show specific parts of the locking device for the household bean milk and bean curd maker, according to the first embodiment of the present invention, when the maker is locked;

FIG. 5 is a sectional view to show specific parts of the locking device for the household bean milk and bean curd maker, according to the first embodiment of the present invention, when the maker is locked;

FIG. 6 is a perspective view to show specific parts of a locking device for a household bean milk and bean curd maker, according to the second embodiment of the present invention, when the maker is unlocked;

FIG. 7 is a perspective view to show the specific parts of the locking device for the household bean milk and bean curd maker, according to the second embodiment, when the maker is locked; and

FIG. 8 is a sectional view to show the specific parts of the locking device for the household bean milk and bean curd maker, according to the second embodiment, when the maker is locked.

### DETAILED DESCRIPTION OF THE INVENTION

Hereinafter, preferred embodiments of the present invention will be described in detail with reference to the attached drawings so that those skilled in the art may easily implement this invention. The above and other objects, features and other advantages of the present invention will be more clearly understood from the following detailed description.

Since the preferred embodiments of the present invention have been disclosed for illustrative purposes, those skilled in the art will appreciate that various modifications, additions and substitutions are possible, without departing from the scope and spirit of the invention as disclosed in the accompanying claims.

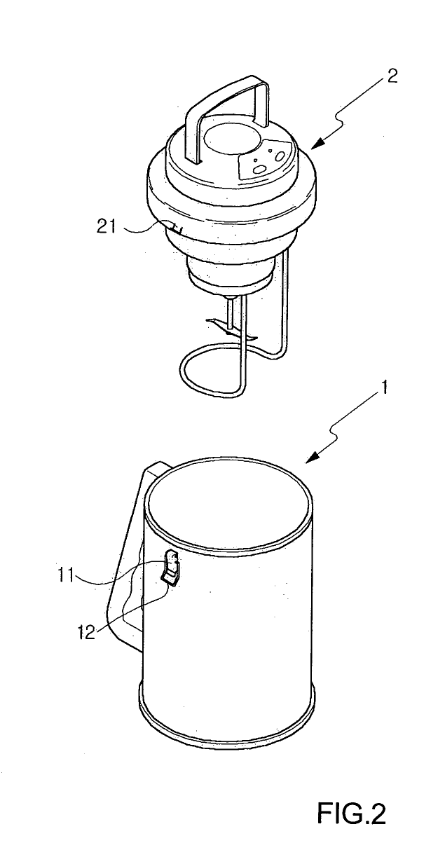

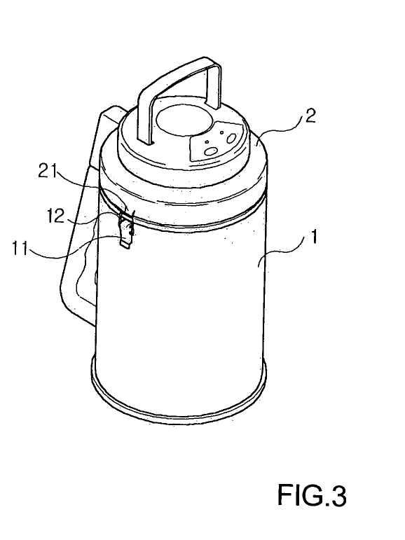

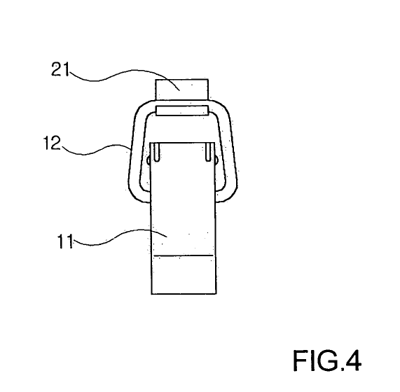

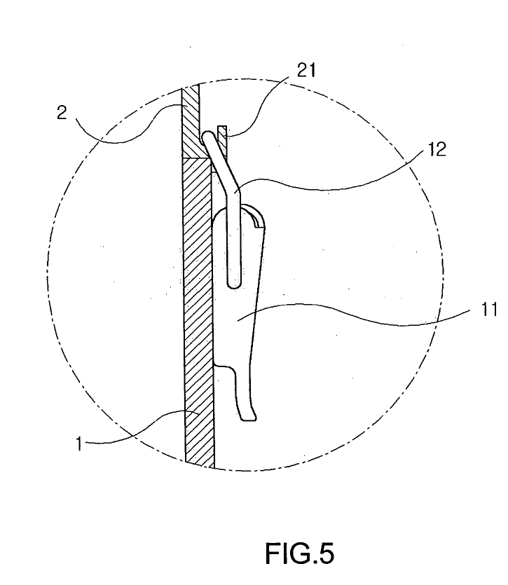

A locking device for a household bean milk and bean curd maker according to the first embodiment of the present invention is constructed as follows. As shown in FIGS. 2 to 5, the household bean milk and bean curd maker includes a housing 1 and a main body 2. The housing 1 has a cavity therein. The main body 2 is provided on an upper portion of the housing 1 to open or close the housing 1, like a lid. Further, the locking device for the household bean milk and bean curd maker includes a hook plate 11, a hook 12, and a locking catch 21. The hook plate 11 is rotatably mounted to a predetermined position on an outer surface of the housing 1. The hook 12 is rotatably coupled to the hook plate 11. The locking catch 21 protrudes from a surface of the main body 2 to engage with the hook 12.

The operation of the locking device for the household bean milk and bean curd maker constructed as described above is as follows.

When a user desires to couple the main body 2 to the housing 1, the hook 12 is put into the locking catch 21, and a lower end of the hook plate 11 is pushed. At this time, the locking catch 21 and the hook plate 11 pull the hook 12 upward and downward. Thus, the hook 12 firmly engages with the locking catch 21, and the household bean milk and bean curd maker is locked.

In this case, the main body 2 and the housing 1 are compressed against each other by the elastic force of the hook 12, thus preventing hot contents from flowing out of the maker, even if the maker falls down by mistake, therefore preventing the user from being injured.

When the maker has stopped, and the user desires to separate the main body 2 from the housing 1, the lower end of the hook plate 11 is pulled outward. Consequently, the hook 12, which is supported at both ends thereof by the locking catch 21 and the hook plate 11, disengages from the locking catch 21, so that the maker is unlocked.

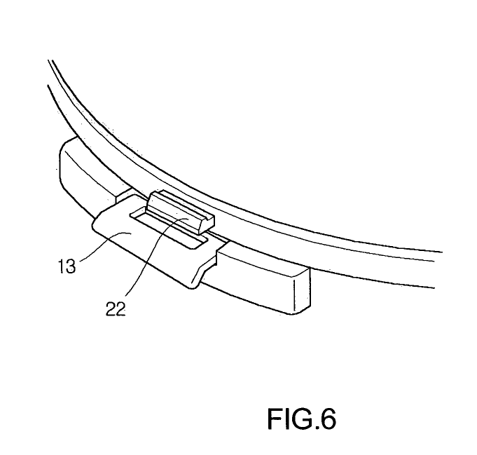

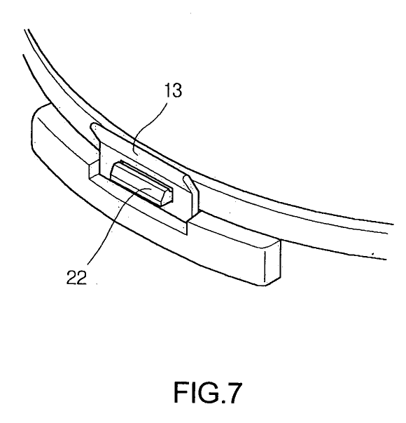

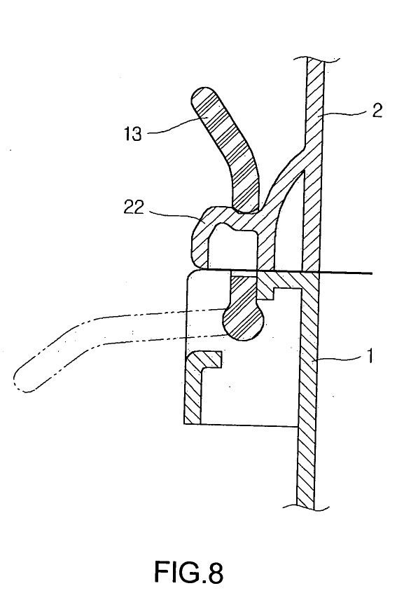

Meanwhile, a locking device for a household bean milk and bean curd maker according to the second embodiment of the present invention is constructed as follows. As shown in FIGS. 6 to 8, the household bean milk and bean curd maker includes a housing 1 and a main body 2. The housing 1 has a cavity therein. The main body 2 is provided on an upper portion of the housing 1 to open or close the housing 1, like a lid. Further, the locking device for the household bean milk and bean curd maker includes a hook 13, and a locking catch 22. The hook 13 is rotatably mounted to a predetermined position on an outer surface of the housing 1, with a hole formed in a center of the hook 13. The locking catch 22 protrudes from a surface of the main body 2 to be inserted into the hole in the hook 13, so that the locking catch 22 engages with the hook 13.

The operation of the locking device for the household bean milk and bean curd maker constructed as described above is as follows.

When a user desires to couple the main body 2 to the housing 1, the hook 13 is rotated upward such that the locking catch 22 is inserted into the hole formed in the center of the hook 13. In this case, the hook 13 firmly engages with the locking catch 22, so that the household bean milk and bean curd maker is locked.

In this case, the main body 2 and the housing 1 are compressed against each other by the elastic force of the hook 22, thus preventing the hot contents from flowing out of the maker, even if the maker falls down by mistake, therefore preventing the user from being injured.

When the maker has stopped and the user desires to separate the main body 2 from the housing 1, the hook 13 is separated from the locking catch 22, and then the hook 13 is rotated downward. Thereby, the maker is unlocked.

As described above, the present invention provides a locking device for a household bean milk and bean curd maker, which locks the maker while compressing a main body and a housing against each other, thus offering a high resistance to vibration, and preventing accidents.

While this invention has been described as having a preferred design, it is understood that it is capable of further modifications, and uses and/or adaptations of the invention and including such departures from the present disclosure as come within the known customary practice in the art to which the invention pertains, and as may be applied to the central features hereinbefore set forth, and fall within the scope of the invention or limits of the claims appended hereto.

1. A locking device for household bean milk and bean curd makers each having a housing defining a cavity therein, and a main body provided on an upper portion of the housing to open or close the housing, the locking device comprising:
a) a hook plate rotatably mounted to a predetermined position on an outer surface of the housing;
b) a hook rotatably coupled to the hook plate; and
c) a locking catch protruding from a predetermined position on the main body to engage with the hook.

2. A locking device for household bean milk and bean curd makers each having a housing defining a cavity therein, and a main body provided on an upper portion of the housing to open or close the housing, the locking device comprising:
a) a hook rotatably mounted to a predetermined position on an outer surface of the housing, with a hole formed in a center of the hook; and
b) a locking catch protruding from a predetermined position on the main body to be inserted into the hole in the hook, so that the locking catch engages with the hook.
